(19) United States
(12) Patent Application Publication
(10) Pub. No.: US 2006/0290031 A1
(43) Pub. Date: Dec. 28, 2006

(54) Method of nanofibres production from a polymer solution using electrostatic spinning and a device for carrying out the method

(76) Inventors: Oldrich Jirsak, Liberec (CZ); Fillip Sanetrnik, Liberec (CZ); David Lukas, Liberec (CZ); Vaclav Kotek, Liberec (CZ); Lenka Martinova, Liberec (CZ); Jiri Chaloupek, Usti nad Labem (CZ)

Correspondence Address: DORITY & MANNING, P.A., POST OFFICE BOX 1449, GREENVILLE, SC, 29602-1449, US

(21) Appl. No.: 10/570,806

(22) PCT Filed: Sep. 8, 2004
(86) PCT No.: PCT/CZ04/00056

§ 371 Date: Mar. 6, 2006

(30) Foreign Application Priority Data
Sep. 8, 2003 (CZ) PV 2003-2421

(51) Int. Cl. H05B 7/00

(52) U.S. Cl. 264/465; 264/468

(57) ABSTRACT

The invention relates to a method of nanofibres production from a polymer solution using electrostatic spinning in an electric field created by a potential difference between a charged electrode and a counter electrode. The polymer solution (2) is for spinning supplied into the electric field using the surface of the rotating charged electrode (30), while on a part of the circumference of the charged electrode (30) near to the counter electrode (40) is a spinning surface created, by which is a high spinning capacity reached. Further the invention relates to a device for carrying out the method, where the charged electrode (30) is pivoted and by its (bottom) part of its circumference it is immersed in the polymer solution (2), while against the free part of the circumference of the charged electrode (30) is positioned the counter electrode (40).

### TECHNICAL FIELD

The invention relates to a method of nanofibres production from a polymer solution using electrostatic spinning in an electric field created by a potential difference between a charged electrode and a counter electrode.

Further the invention relates to a device for carrying out the method consisting of a charged electrode and a counter electrode of a different potential, where in between them an electric field is created.

### BACKGROUND ART

Polymer fibres with diameters between 10 nm to 1.000 nm represent a new grade of materials with some properties of extreme values. Such a typical field of use of polymer fibres layers is a filtration of gases and liquids, barrier materials for entrapment of submicron particles, bacteria and chemicals, where there is a very high filtering efficiency reached. Nanofibres are used as battery separators, composite reinforcement and as pharmaceutical carriers and tissue implants carriers in medicine. A high specific surface of nanofibres easily accessible to gaseous and liquid media predetermines for their special sorptive properties and for their use as carriers of different active ingredients, e.g. catalysators. Extremely small pores in layers of nanofibres are a condition for extreme thermal insulating properties.

Nanofibres are made of a broad range of polymers, polymer blends and from blends of polymers with low molecular additives by processes of polymer solutions forming. Unlike in on principle similar processes of polymer melts forming is in solutions processing reached smaller diameters of fibres due to lower solutions viscosities. For solutions forming is used mechanical forces of flowing gaseous medium or coulombic forces in electrostatic field. Electrostatic spinning leads to fibres of lower diameters because single forming fibres are owing to distribution of equivalent charge in their volume split in a number of filaments.

Up to the day known methods and devices for production of nanofibres by polymer solutions forming by an air stream are described for example in U.S. Pat. No. 6,382,526 and U.S. Pat. No. 6,520,425. Polymer solutions are injected into a spinning jet of an annular section. The solutions are then formed by a mechanical action of an air stream delivered inside of the annulus, or as the case may be outside of this annulus, to produce fibres of diameters of 200 nm to 3.000 nm.

Forming of polymer solutions using electrostatic field of mean intensity 50.000 V/m to 500.000 V/m is described in patent applications WO 0.127.365, WO 0.250.346, US 2002/0.175.449 A1 and US 2002/084.178 A1. According to these solutions is the polymer solution distributed into cylindrical spinning jets with inside diameter 0,5 mm to 1,5 mm. These jets are connected to a source of DC voltage. The effluent solvent is by the electrostatic force attracted to the counter electrode, which is usually grounded and at the same time it is by this force formed into fine filaments, which are consequently split in a filament bundle of corresponding smaller diameter. Spinning is performed from one jet or an array of static or moving jets with aim to increase the capacity of the device, even coverage of counter electrode or plane supporting material moving on a surface of counter electrode or in the vicinity of its surface.

The drawback of all above mentioned methods and devices for nanofibres production is a very small amount of processed polymer material in time. In the case of nanofibres forming by mechanical forces the diameter of produced nanofibres depends among others on a ratio of air mass and polymer solution flowing through the spinning jet. While forming by coulombic force in electrostatic field, there must be formed so called Taylor cone at the throat of the spinning jet, whose existence is a requirement for fibres formation and it is conditioned by a relatively narrow range of ratio of discharge velocity of the polymer solvent from the spinning jet to the intensity of electrostatic field. The maximum adjustable intensity of electrostatic field is limited by dielectric strength of air and above this limit discharges between electrodes happen. In consequence of above mentioned circumstances and attainable concentrations of spinning polymer solutions it is possible to process approximately 0,1 g to 1 g of polymer in an hour in one spinning jet, which from the industrial point of view makes the production of nanofibres very problematic.

The aim of the invention is to create a method and a device industrially applicable and able to reach a high spinning capacity.

### PRINCIPLE OF THE INVENTION

The aim of the invention has been reached by a method of nanofibres production according to the invention, whose principle consists in that the polymer solution is for spinning delivered into the electrostatic field by a surface of a rotating charged electrode, while on a part of the circumference of the charged electrode near to a counter electrode is a spinning surface created. The polymer solution is in favourable conditions able to create in electric field Taylor cones not only while discharge from a spinning jet but also on the surface of its level, in particular advantageously in a thin layer on a surface of a rotating body partly immersed in a container with this solution. By the mentioned favourable conditions is meant appropriate viscosity of the solution given by the molecular weight of the polymer, his concentration and temperature, appropriate surface tension given by the type of polymer and a presence of surface active ingredient and appropriate value of electric conductivity of the solution available by the presence of low molecular electrolyte. The dimension of the spinning surface is adequate to the dimensions and the shape of the charged electrode and the counter electrode. The number of forming nanofibres is adequate to the dimensions and the shape of the spinning surface.

According to Claim 2 it is advantageous that the nanofibres produced from the polymer solution on the spinning surface of the charged electrode by the action of electrostatic field are by the electric field drift to the counter electrode and they are laid down before it onto a means for nanofibres storage and form a layer on it. This method enables to produce layers of nanofibres with a high quality and uniformity of the layer, basically in arbitrary widths corresponding to the width of the device.

The next improvement is reached according to Claim 3. The action of air stream together with electric field promotes drift of the fibres out of the charged electrode.

However, it is advantageous if the nanofibres are drift away towards counter electrode and are stored on a means for nanofibres storage pervious to air in front of the counter electrode and form a layer on it.

Air strem directing to the counter electrode is created by sucking the air according to Claim 5. Using this simple method the drift of fibre towards the counter electrode is promoted and the productivity is increased.

According to Claim 6 the nanofibres are in the space between the charged electrode and the counter electrode by the air stream deflected from their course towards the counter electrode and they are led to the means for nanofibres storage pervious to air, which is situated outside of the electrical field causing spinning of the polymer solution.

The air stream for deflecting the nanofibres from their course from the charged electrode towards the counter electrode is according to Claim 7 advantageously produced by sucking of the air from the space between the electrodes into the space behind the means for nanofibres storage pervious to air in regard of the charged electrode.

For increased productivity of the device it is advantageous if, according to Claim 8, into the space where the nanofibres are drift away is an auxiliary drying air supplied, by which the evaporation of the polymer solvent from nanofibres is accelerated, where the nanofibres are produced by electrostatic spinning and moving in the space between the electrodes.

While to increase drying efficiency, that is acceleration of evaporation of the polymer solvent, it is advantageous, when at least a part of auxiliary drying air is drawn out of the space in front of the supporting device pervious to air in regard of the charged electrode, without passing through this device.

Also the method according to Claim 10 serves to increase the productivity of the device because heating up the delivered auxiliary drying air enables the possibility to draw away a bigger amount of solvent vapours created while drying the nanofibres.

For all embodiments of the method it is advantageous the use of aqueous polymer solution because the overall construction of the device is easier and there is no need for removal of harmful or dangerous gases from the polymer solvent.

Device according to Claim 12 describes the basic characters of the device for carrying out above described methods and whole point is that the charged electrode is pivoted and by a part of its circumference it is immersed in the polymer solution, while against the free part of the circumference of the charged electrode, there is the counter electrode positioned. Such arranged device is able to deliver sufficient amount of the polymer solvent into the electric field.

In the embodiment according to Claim 13 the counter electrode surrounds the free parts of the circumference of the charged electrode along its entire length, while in the entire space between the electrodes an electric field of the same intensity is created.

Between both electrodes, there is the means for nanofibres storage situated, on which surface the nanofibres are laid down in layers.

There is an advantageous embodiment of the device according to Claims 15 and 16, where the means for nanofibres storage is pervious to air and there is an air stream passing through this device produced.

In alternative embodiment according to Claim 17 there is outside of the space between the electrodes positioned a means for nanofibres storage pervious to air and behind it there is a vacuum produced forming an air stream drifting the nanofibres away of the space between the electrodes towards the means for nanofibres storage through which passes at least a part of the air. In foregoing embodiments of the device it is advantageous to form a means for nanofibres storage according to any of Claims 18 to 22.

For increased evaporation of the solvent from nanofibres, there is into the device an auxiliary drying air supplied according to any of Claims 23 o 25.

Advantageous embodiments of the charged electrode are described in Claims 26 to 28 and the aim is to reach the best possible spinning efficiency of the device, in which they are going to be used.

### DESCRIPTION OF THE DRAWING

Examples of a device embodiment according to the invention are schematically shown in the enclosed drawings where

FIG. 1 is a cross section of a device with a counter electrode surrounding a part of the circumference of a charged electrode,

FIG. 2 is a cross section of an embodiment of the device with a means for nanofibres storage outside of the space between the electrodes,

FIG. 3 is a cross section of the device, where the means for nanofibres storage is formed by a plane supporting material positioned between the electrodes in the conveyance composed of stretching elements,

FIG. 4 is an embodiment similar as FIG. 1 with a fixed electrode composed of longitudinal rods and the conveyance of plane supporting material of nanofibres arranged between these rods,

FIG. 5a to 5e is a view at various embodiments of the surface of a cylinder presenting charged electrode from the front and from the side.

### SPECIFIC DESCRIPTION

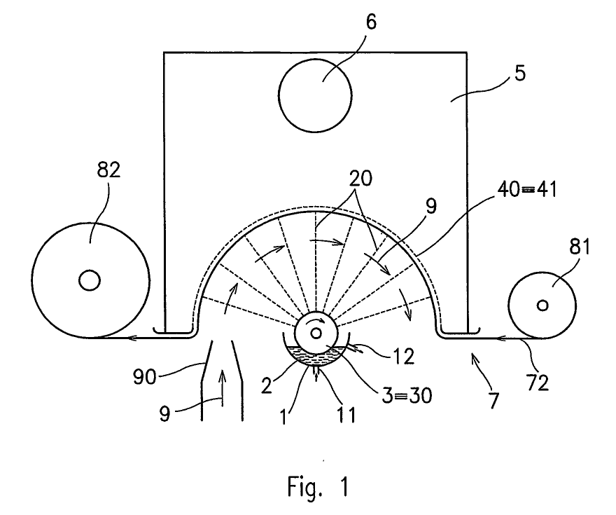

A device for nanofibres production from a polymer solution using electrostatic spinning in an electric field created by a potential difference between a charged electrode and a counter electrode consisting of a container 1 at least partly filled with a polymer solution 2 in which is by a part of its circumference immersed pivoted cylinder 3, which is by a well-known not represented method connected to a source of DC voltage and which forms a charged electrode 30. Against a free part of the circumference of the charged electrode 30 is a counter electrode 40 with a different potential situated, which is usually connected to earth (grounded), as described in FIG. 1, or it is by a well-known not represented method connected to a source of DC voltage of a different polarity.

In the not represented embodiments is the cylinder 3 immersed in the polymer solution 2 by the bottom part of its circumference. Such arrangement can be changed according to the not represented example, where with polymer solution is filled a closed container, from which is on surface of the charged electrode distributed the polymer solution or the cylinder presenting the charged electrode is in such closed container positioned, while the polymer solution is wetting for example the top part of the circumference of the cylinder, which draws on its circumference appropriate amount of the polymer solution from the container.

In the example of embodiment shown in FIG. 1 is the counter electrode 40 made of a perforated conducing material, e.g. sheet metal, shaped in a cylindrical surface, which forms the front end of a vacuum chamber 5, which is connected to a vacuum source 6. A part of the surface of the counter electrode 40 near the charged electrode 30 serves as a conveyance 41 for plane supporting material 72 of the nanofibres pervious to air, which is for example made of a backing fabric and which is positioned on an unreeling device 81 arranged on one side of the vacuum chamber 5 and on the reeling device 82, which is arranged on the other side of the vacuum chamber 5. In this represented embodiment the plane supporting material 72 of the nanofibres forms in itself a means 7 for nanofibres storage pervious to air.

The polymer solution 2 container 1 is open and fitted with at least one polymer solution 2 inlet 11 and at least one polymer solution 2 outlet 12. The mentioned polymer solution inlet 11 and outlet 12 serves to provide circulation of the polymer solution 2 and to maintain the constant height of its level in the container 1.

To the space between the charged electrode 30 and the counter electrode 40 is an auxiliary drying air 9 supply 90 assigned, which can be according to the well-known manner heated up as needed, for example using a heating device 91 arranged in the auxiliary drying air 9 supply 90. The auxiliary drying air 9 is from the space between the charged electrode 30 and the counter electrode 40 either completely or partly sucked into the vacuum chamber 5 or it comes out on the other side than it is supplied.

By rotating the charged electrode 30′ where its part of its circumference is immersed in the polymer solution 2, is the polymer solution 2 drawn by the circumference of the charged electrode 30 from the container 1 into the space between the charged electrode 30 and the counter electrode 40, where an electric field is formed. Here on the surface of the charged electrode 30 are from the polymer solution 2 formed Taylor cones of a high stability and they present places of primary formation of the nanofibres 20. The formed nonofibres 20 are by the effects of electric field drift away to the counter electrode 40 and consequently they are deposited on the surface of the backing fabric presenting plane supporting material 72 of the nanofibres into a layer, which thickness is controlled using the velocity of the unreeling device 81 and the reeling device 82.

The drift of the nanofibres 20 away of the charged electrode 30 to the counter electrode 40 is promoted by streaming of air sucked from the outer space into the vacuum chamber 5 and passing along the polymer solution 2 container 1 and the charged electrode 30 and passing through the backing fabric presenting plane supporting material 72 of the nanofibres and the counter electrode 40.

In the embodiment shown in FIG. 4 is the counter electrode 40 manufactured using another appropriate method, for example from rods 400 parallel to the pivoted cylinder 3 presenting the charged electrode 30. Between the rods 400 forming the counter electrode 40 there are arranged auxiliary rods 410 forming conveyance 41 for plane supporting material 72 of the nanofibres that forms the means 7 for nanofibres storage. Nevertheless, some or all of the auxiliary rods 410 can be rotable to lower friction drag while conveying the supporting material 72 of the nanofibres. The conveyance for the supporting material 72 of the nanofibres can be in this embodiment composed also of rods 400 forming counter electrode 40. In the described device the nanofibres 20 are produced in a high number so the limiting factor of the spinning device capacity is the evaporation rate of the polymer solvent from produced nanofibres 20 and the rate of drawing off of the evaporated solvent, which would in a short period create a saturated vapour state not permitting another solvent evaporation in the space between the charged electrode 30 and the counter electrode 40. The device is therefore fitted with the auxiliary drying air 9 supply 90, which provides drawing off of the solvent vapours especially from the space between the charged electrode 30 and the counter electrode 40. To increase the effect this auxiliary drying air 9 can be heated up.

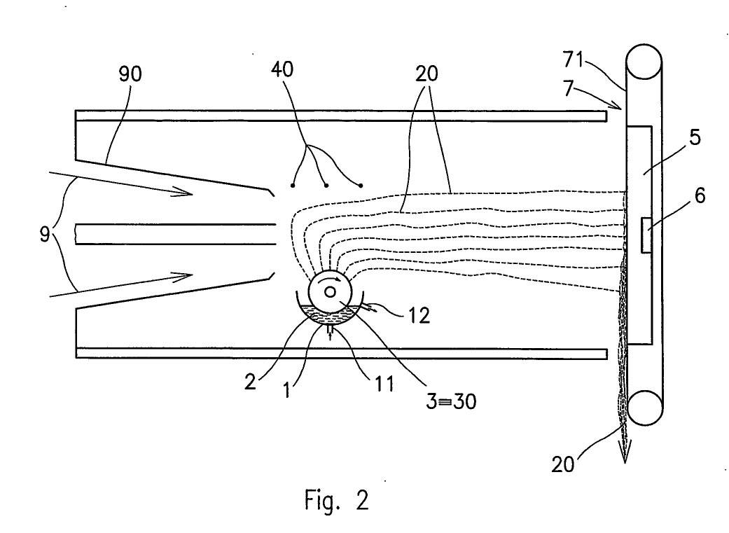

The next example according to the invention is described in FIG. 2, where as well as in the embodiment according to the FIG. 1 the charged electrode 30 is pivoted and by a part of its circumference it is positioned in the polymer solution 2, which is in the container 1 and its circulation and the level in the container 1 is maintained by flowing of the polymer solution 2 through the inlet 11 and the outlet 12. Against the free part of the circumference of the pivoted charged electrode 30, there is the counter electrode 40 positioned composed of a system of wires or rods connected to earth (grounded) or by a well-known not represented manner connected to a source of DC voltage of opposite polarity than the charged electrode 30. Outside of the space between the electrodes (30, 40), where the electrostatic field is created and where by electrostatic spinning the nanofibres 20 from the polymer solution 2 are produced, there is positioned a conveyor 71 of nanofibres pervious to air, which form the device 7 for nanofibres storage behind which is arranged the vacuum chamber 5 connected to the vacuum source 6.

The nanofibres 20 directing due to the action of electric field from the charged electrode 30 to the counter electrode 40 are by the action of air stream sucked into the vacuum chamber 5 deflected from their course and are drift onto the conveyor 71 pervious to air, onto which surface they are stored in a layer, which is by the motion of the conveyor 71 carried out of the device and consequently by an appropriate not represented manner processed, conditioned or stored. For the aim to increase the amount of air in the space between the electrodes 30, 40 is the device fitted with the inlet 91 of auxiliary drying air 9, which enters the device casing in the direction to the conveyor 71 pervious to air, which further promotes deflecting the nanofibres 20 from the course to the counter electrode 40 to the direction to the conveyor 71 pervious to air.

Also in this embodiment there is a possibility of various modifications in arrangement and shape of the counter electrodes. There is also possibility to insert in front of the conveyor 71 pervious to air a backing fabric or another plane supporting material 72 and the layer of the nanofibres 20 can be stored onto this plane supporting material 72.

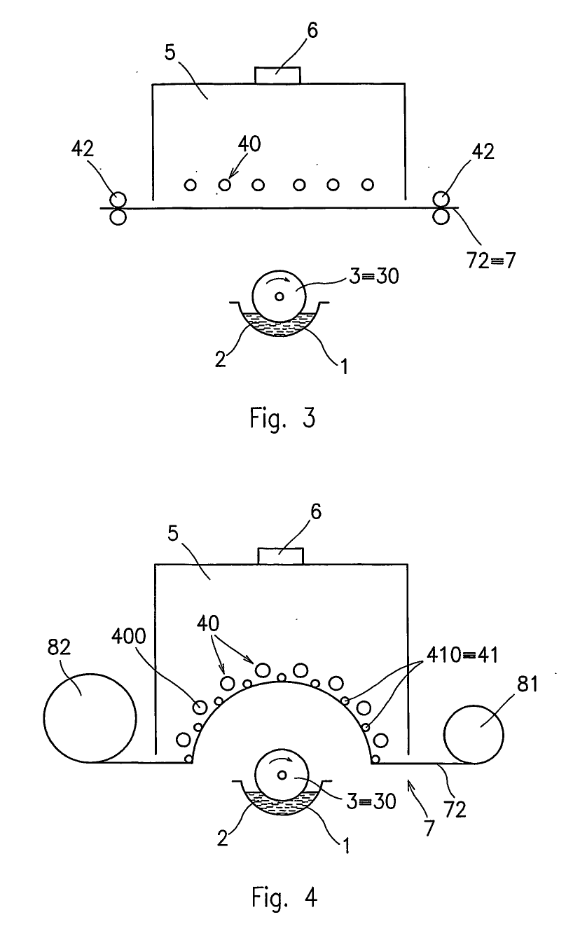

In the FIG. 3 is described an embodiment of the device consisting of pivoted charged electrode 30 immersed by bottom part of its circumference into the polymer solution 2. Against the free part of the circumference of the pivoted charged electrode 30, there is positioned the counter electrode 40 composed of a system of rods parallel to the axis of rotation of the charged electrode 30 and through the space between the electrodes 30, 40 is conveyed the plane supporting material 72 of the nanofibres using conveyance 41 composed of stretching elements 42.

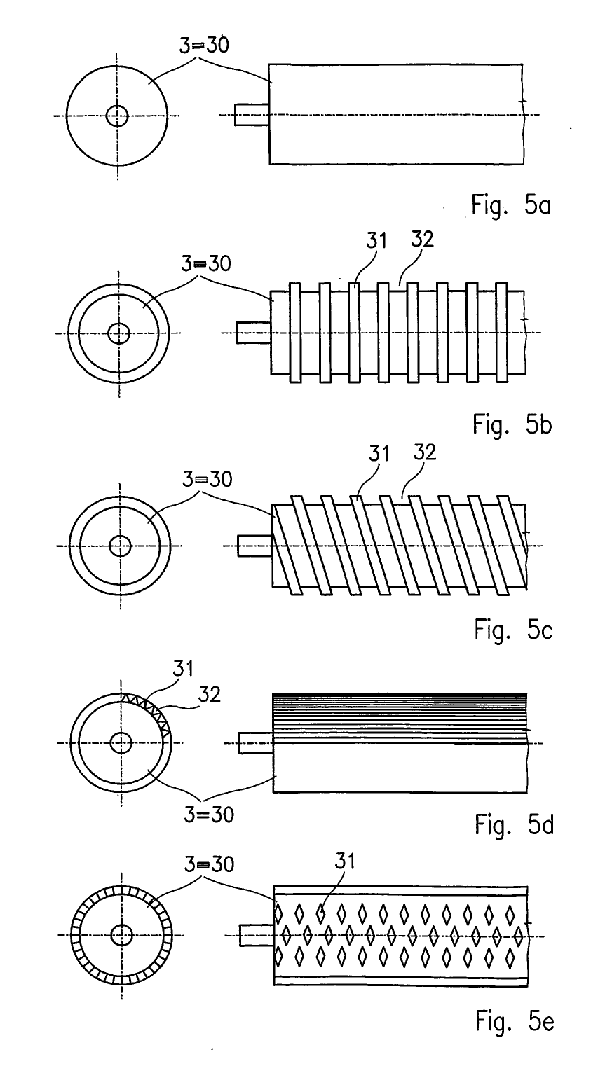

The charged electrode 30 is composed of a body able to rotate, for example a cylinder, quadrangular or multiangular prism and the like, while it is advantageous if the axis of rotation is at the same time the axis of symmetry of the used body. The cylinder 3 is on the circumference fitted with lugs 31 and/or recesses 32. Examples of shapes of the cylinder surface appropriate for the charged electrode are described in the FIG. 5a to 5e, while these shapes do not limit all possible embodiments but serve only as an example. In up to now described embodiments, there is created a steady electric field between the electrodes. The device is possible to be fit with means for creating an intermittent electric field if it is necessary for creating or storage of the nanofibres 20 layer.

Specific examples are described below.

### EXAMPLE OF EMBODIMENT 1

The polymer solution 2 container 1 of the device according to the FIG. 1 is being filled with 12% aqueous polyvinyl alcohol solution with 88% degree of hydrolysis of a molecular weight M_{w}=85.000, containing 5 mole percent citric acid as a crosslinking agent referred to structural units of the polymer. The viscosity of the solution is 230 mPa·s at 20° C., specific electric conductivity 31 mS/cm and surface tension 38 mN/m. The polymer solution 2 flows into the container 1 through an inlet II and flows off through an outlet 12 while the level height of the polymer solution 2 in the container 1 is maintained using the position of the outlet 12. The charged electrode 30 consists of a cylinder 3 of 30 mm in diameter in the embodiment according to the FIG. 5c and it is rotating clockwise in 2,5 RPM. The cylinder 3 is connected to +40 kV DC voltage source. The device is manufactured according the FIG. 1 and throughout it is led a backing fabric forming a plane supporting material 72 of the nanofibres. Owing to the low pressure in the low pressure chamber 6 behind the counter electrode 40 pervious to air, the plane material abuts to the counter electrode 40, which forms this way the plane material conveyance. The surface of the rotating cylinder 3 draws the polymer solution 2 out of the container 1 and owing to the electric field between the electrodes 30, 40 it forms Taylor cones and the nanofibres 2 in diameters 50 to 200 nanometers. The nanofibres 20 are drift away to the counter electrode 40 and they are stored on the running backing fabric, where they form a layer of thickness that can be controlled by the movement speed of the backing fabric. Into the space between the electrodes is an auxiliary drying air 9 of the temperature of 50° C. supplied. The layer of nanofibres is produced in the amount of 1,5 g/min for one meter length of rotating cylinder 3.

### EXAMPLE OF EMBODIMENT 2

The polymer solution 2 container 1 of the device according to the FIG. 2 is being filled with 10% aqueous polyvinyl alcohol solution with 98% degree of hydrolysis of a molecular weight M_{w}=120.000, containing 5 mole percent citric acid as a crosslinking agent referred to structural units of the polymer. The viscosity of the solution is 260 mPa·s at 20° C., its specific electric conductivity has been adjusted by an addition of a small amount of aqueous NaCl solution to 25 mS/cm and the surface tension has been adjusted by addition of 0,25% nonionogene surface active agent to 36 mN/m. The polymer solution 2 flows into the container 1 through an inlet 11 and flows off through an outlet 12, where its position determines the level height of the polymer solution 2 in the container 1. The cylinder 3 presenting the charged electrode is 50 mm in diameter and has a smooth surface described in the FIG. 5a. The cylinder 3 is connected to +40 kV DC voltage source and the wire counter electrode 40 to negative 5 kV DC voltage source. In the space between the charged electrode 30 and the counter electrode 40 are produced nanofibres 20 in a diameter of 50 to 200 nanometers, which are by the air sucked from the space between the electrodes 30, 40 into the vacuum chamber 5 and using the auxiliary drying air 9 drift to the surface of the conveyor 71 pervious to air, where they are stored in a fibre layer in the amount of 1,8 g/min for one meter length of rotating cylinder.

### INDUSTRIAL APPLICABILITY

A method and a device according to the invention are applicable for production of layers of nanofibres in diameters from 50 to 200 nanometers. These layers can be used for filtration, as battery separators, for production of special composites, for construction of sensors with extremely low time constant, for production of protective clothes, in medicine and other fields.

1. A method of nanofibres production from a polymer solution using electrostatic spinning in an electric field created by a potential difference between a charged electrode and a counter electrode, characterized by that the polymer solution (2) is supplied into the electric field for spinning using the surface of the rotating charged electrode (30), while on a part of the circumference of the charged electrode (30) near to the counter electrode (40) is a spinning surface (31) created, by which is a high spinning capacity reached.

2. A method as claimed in claim 1, characterized by that the nanofibres (8) produced by the action of electrostatic field from the conducting polymer solution (2) on a spinning surface (31) of the charged electrode (30) are by the electric field drift away to the counter electrode (40) and before it they are laid down onto a device (7) for nanofibres storage and form a layer on it.

3. A method as claimed in claim 1 or 2, characterized by that an air stream acts on nanofibres (8) in the space between the charged electrode (30) and the counter electrode (40), which promotes the nanofibres (8) to drift away of the charged electrode (30).

4. A method as claimed in claim 3, characterized by that the nanofibres (8) are by an air stream drift away towards the counter electrode (40) before which they lay down onto the device (7) for nanofibres storage and form a layer on it.

5. A method as claimed in claim 4, characterized by that the air stream is produced by sucking of the air from the space between the electrodes (30, 40) into the space behind the counter electrode (40).

6. A method as claimed in claim 3, characterized by that the nanofibres are by the air stream deflected from their course towards the counter electrode (40) and are led to the device (7) for nanofibres storage pervious to air, onto which surface they are stored in a layer in a space out of reach of the electric field between the electrodes (30, 40) where they were produced.

7. A method as claimed in claim 6, characterized by that the air stream is produced by sucking of the air from the space between the electrodes (30, 40) into the space behind the device (7) for nanofibres storage pervious to air in regard of the charged electrode (30).

8. A method as claimed in any of claims 4, 5, 6 or 7, characterized by that into the space where the nanofibres are drift away is an auxiliary drying air (9) supplied.

9. A method as claimed in claim (8), characterized by that at least a part of the auxiliary drying air (9) is drawn off the space in front of the device (7) for nanofibres storage pervious to air in regard of the charged electrode (30), without passing through this device (7).

10. A method as claimed in any of claims 3 to 9, characterized by that at least an auxiliary drying air (9) is heated up before entering the space where the nanofibres (8) are drift away.

11. A method as claimed in any of claims 1 to 10, characterized by that the polymer solution (2) is composed of a water solution.

12. A method for carrying out the method as claimed in claims 1 to 11 comprising the charged electrode and the counter electrode with a different potential between which an electric field is formed, characterized by that the charged electrode (30) is pivoted and by a part of its circumference it is immersed in the polymer solution (2), while against the free part of the circumference of the charged electrode (30), there is the counter electrode (40) positioned.

13. A method as claimed in claim 12, characterized by that the counter electrode (40) surrounds the free parts of the circumference of the charged electrode (30) along its entire length.

14. A device as claimed in claim 12 or 13, characterized by that between both electrodes (30, 40) is situated the device (7) for nanofibres storage.

15. A device as claimed in claim 14, characterized by that the device (7) for nanofibres storage is pervious to air, while the space behind this device (7) in regard to the charged electrode (30) is connected to the vacuum source (6) serving to create an air stream directing out of the space between the electrodes (30, 40) towards this device (7).

16. A device as claimed in claim 15, characterized by that the vacuum source (6) is connected with the space behind the counter electrode (40) pervious to air in regard to the charged electrode (30).

17. A device as claimed in claim 12, characterized by that outside of the space between the electrodes (30, 40) is positioned the device (7) for nanofibres storage pervious to air, while the space behind this device (7) in regard to the charged electrode (30) is connected to the vacuum source (6) serving to create an air stream directing towards this device (7).

18. A device as claimed in any of claims 13 to 17, characterized by that the device (7) for nanofibres storage is composed of a conveyor (71) pervious to air.

19. A device as claimed in any of claims 13 to 17, characterized by that the device (7) for nanofibres storage is composed of a plane supporting material of the nanofibres (72).

20. A device as claimed in claim 19, characterized by that the plane supporting material (72) is positioned on a conveyance (41).

21. A device as claimed in claim 20, characterized by that the conveyance (41) is composed of a counter electrode (40).

22. A device as claimed in claim 20, characterized by that the conveyance (41) is composed of stretching elements (42) of plane supporting material (72) of the nanofibres.

23. A device as claimed in any of claims 15 to 22, characterized by that into the space between the electrodes (30, 40) leads an inlet (90) of auxiliary drying air (9).

24. A device as claimed in claim 23, characterized by that in the inlet (90) of auxiliary drying air (9), there is positioned an air heating device (91).

25. A device as claimed in claim 23 or 24, characterized by that at least a part of air is drawn off the space in front of the device (7) for nanofibres storage in regard of the charged electrode (30), without passing through this device (7).

26. A device as claimed in any of claims 12 to 25, characterized by that the charged electrode (30) is composed of an axially symmetric body, where the axis is at the same time an axis of rotation.

27. A device as claimed in claim 26, characterized by that the charged electrode (30) is composed of a roll (3).

28. A device as claimed in claim 27, characterized by that the roll (3) is on its circumference fitted with lugs (31) and/or recesses (32).
